(19) United States
(12) Patent Application Publication
(10) Pub. No.: US 2009/0003586 A1
(43) Pub. Date: Jan. 1, 2009

(54) SIGNAL PROCESSOR AND METHOD FOR CANCELING ECHO IN A COMMUNICATION DEVICE

(75) Inventors: Shien-Neng Lai, Taipei County (TW); Cong-Zhou Liu, Guang Dong Province (CN)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: FORTEMEDIA, INC., Cupertino, CA (US)

(21) Appl. No.: 11/769,765

(22) Filed: Jun. 28, 2007

(51) Int. Cl. H04M 9/08

(52) U.S. Cl. 379/406.01

(57) ABSTRACT

The invention provides a signal processor installed in a communication device. In one embodiment, the signal processor comprises a voice activity detector, a nonlinear echo processor, and a speaker attenuation module. The voice activity detector generates a control signal indicating whether both a far-end talker at a far end and a near-end talker at a near end are speaking or only the far-end talker is speaking. The nonlinear echo processor, controlled by the control signal, cancels more nonlinear echo from the near-end signal in time domain while only the far-end talker is speaking and cancels less nonlinear echo from the near-end signal in time domain while both the far-end talker and the near-end talker are speaking. The speaker attenuation module, controlled by the control signal, attenuates the far-end signal while both the far-end talker and the near-end talker are speaking.

### BACKGROUND OF THE INVENTION

1. Field of the Invention

The invention relates to echo cancellation, and more particularly to nonlinear echo cancellation of full-duplex communication systems.

2. Description of the Related Art

Efficiency of echo cancellation greatly affects performance of full-duplex communication systems, such as speakerphones, hands-free car kits, and conferencing systems. A full-duplex communication device receives a far-end signal of a far-end talker through a communication link and plays the far-end signal with a speaker. At the same time, a microphone of the full-duplex communication device captures a near-end signal of a near-end talker and sends the near-end signal to the far-end talker through the communication link. When the speaker plays the far-end signal, a portion of the far-end signal is captured by the microphone with the near-end signal, and echo is thus formed. If the communication device does not cancel the echo, the echo is transmitted to the far-end talker with the near-end signal, degrading quality of the near-end signal.

A communication device implements echo cancellation with a digital signal processor. FIG. 1 is a block diagram of a communication device 100 with a signal processor 150 canceling echo. The signal processor 150 comprises a voice activity detector 101, a linear echo canceller 102, a Fast Fourier Transformation (FFT) module 124, a noise suppression processor 103, an Inverse Fast Fourier Transformation (IFFT) module 125, and a nonlinear echo processor 104. A digital-to-analog converter 111 converts a far-end signal S_{f1} from digital to analog to obtain a far-end signal S_{f2}, which is then amplified by an amplifier 112 and played out by a speaker 113.

A microphone 121 of the communication device 100 then captures sounds in the vicinity to form a near-end signal Sₙ₁. The near-end signal Sₙ₁ comprises a near-end talker's voices, noises, and echo derived from the far-end signal. The near-end signal Sₙ₁ is then amplified and converted from analog to digital to obtain a signal Sₙ₃. Two modules of the signal processor 150, the linear echo canceller 102 and the nonlinear echo processor 104, respectively eliminate linear echo and nonlinear echo from the near-end signal. The voice activity detector 101 first detects a power of the far-end signal S_{f1} to generate a control signal A₁. If the voice activity detector 101 detects that the power of the far-end signal S_{f1} exceeds a threshold, the far-end talker is talking, and the far-end signal may induce echo in the near-end signal, the control signal A₁ enables the linear echo canceller 102. Otherwise, the voice activity detector 101 issues the control signal A₁ to disable the linear echo canceller 102.

The linear echo canceller 102, which is practically an adaptive filter, derives an echo estimate X from the far-end signal S_{f1} according to an adaptive algorithm and eliminates the echo estimate X from the near-end signal Sₙ₃ to obtain a signal Sₙ₄. The linear echo canceller 102 can only eliminate echo linearly correlated with the far-end signal S_{f1} and therefore referred to as a linear echo canceller. The FFT module 124 then performs FFT on the signal Sₙ₄ to obtain a signal Sₙ₅. The noise suppression processor 103 then eliminates noise from the signal Sₙ₅ in frequency domain to obtain a signal Sₙ₆ without noise, and the IFFT module 125 performs IFFT on the signal Sₙ₆ to obtain a signal Sₙ₇.

The nonlinear echo processor 104 then eliminates remnant echo not linearly correlated with the far-end signal, referred to as non-linear echo, from the signal Sₙ₇ to obtain a signal Sₙ₈, which can be transmitted to the far-end talker. Because nonlinear echo is not correlated with the far-end signal, the nonlinear echo processor 104 has difficulty in distinguishing nonlinear echo from voices carried by the near-end signal Sₙ₇ and cannot completely cancel nonlinear echo in the signal Sₙ₇. A portion of voices of the near-end talker in the signal Sₙ₇ may also be cancelled with nonlinear echo, degrading the quality of the signal Sₙ₈. Thus, a method for canceling echo in a duplex communication device is required.

### BRIEF SUMMARY OF THE INVENTION

The invention provides a signal processor installed in a communication device. The communication device simultaneously plays a far-end signal sent from a far-end and converts sounds at a near-end to a near-end signal for transmission to the far-end. In one embodiment, the signal processor comprises a first voice activity detector, a second voice activity detector, a nonlinear echo processor, and a speaker attenuation module. The first voice activity detector detects a power of the far-end signal to generate a first control signal indicating whether a far-end talker at the far end is speaking. The second voice activity detector generates a second control signal indicating whether both the far-end talker and a near-end talker at the near end are speaking or only the far-end talker is speaking according to power of the near-end signal and the first control signal. The nonlinear echo processor, controlled by the second control signal, cancels more nonlinear echo from the near-end signal in time domain while only the far-end talker is speaking and cancels less nonlinear echo from the near-end signal in time domain while both the far-end talker and the near-end talker are speaking. The speaker attenuation module, controlled by the second control signal, attenuates the far-end signal while both the far-end talker and the near-end talker are speaking.

The invention also provides a method for canceling echo in a communication device. The communication device simultaneously plays a far-end signal sent from a far-end and converts sounds at a near-end to a near-end signal for transmission to the far-end. First, whether both a far-end talker at the far end and a near-end talker at the near end are speaking or only the far-end talker is speaking is determined. More nonlinear echo is then cancelled from the near-end signal in time domain while only the far-end talker is speaking, and less nonlinear echo is then cancelled from the near-end signal in time domain while both the far-end talker and the near-end talker are speaking. Finally, the far-end signal is attenuated while both the far-end talker and the near-end talker are speaking.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 is a block diagram of a communication device with a signal processor canceling echo;

FIG. 2 is a block diagram of an embodiment of a communication device with a signal processor canceling echo according to the invention;

FIG. 3 is a block diagram of another embodiment of a communication device with a signal processor canceling echo according to the invention;

FIG. 4 is a block diagram of still another embodiment of a communication device with a signal processor canceling echo according to the invention;

FIG. 5 is a block diagram of still another embodiment of a communication device with a signal processor canceling echo according to the invention; and

FIG. 6 shows an echo cancellation result of the signal processor of FIG. 3.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

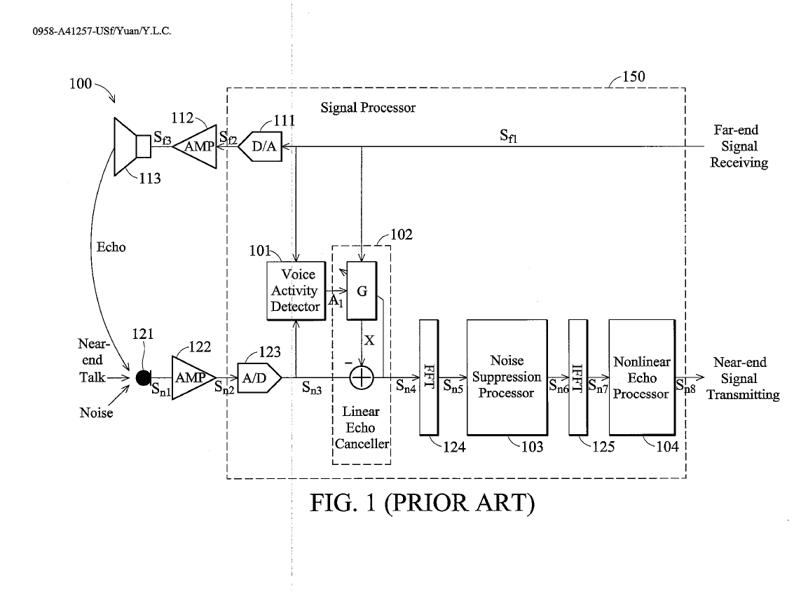

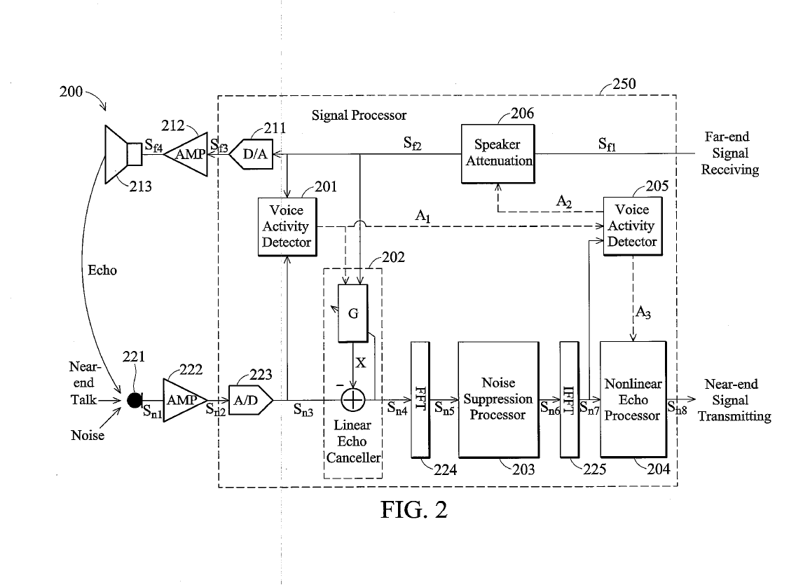

FIG. 2 is a block diagram of a communication device 200 with a signal processor 250 canceling echo according to the invention. The communication device 200 is roughly similar to the communication device 100 of FIG. 1 with the exception that the signal processor 250 further comprises a voice activity detector 205 and a speaker attenuation module 206. Because it is hard for a nonlinear echo processor 204 of the signal processor 250 to discriminate nonlinear echo from voices of a near-end talker, the voice activity detector 205 is added to the signal processor 250 to assist the nonlinear echo processor 204 in identifying nonlinear echo. A voice activity detector 201 first detects whether a power of a far-end signal S_{f2} exceeds a threshold to generate a control signal A₁. Thus, the control signal A₁ indicates whether the far-end talker is speaking. The voice activity detector 205 then detects whether a power of a near-end signal Sₙ₇ exceeds a threshold. If so, the near-end talker is speaking. Thus, the voice activity detector 205 can then generate control signals A₂ and A₃ indicating whether both the near-end talker and the far-end talker are speaking, or only the far-end talker is speaking.

If the control signal A₁ indicates that far-end talker is speaking, and the power of the near-end signal Sₙ₇ falls behind a threshold, only the far-end talker is speaking. At this time, the voice activity detector 205 generates the control signal A₃ to increase an echo cancellation amount of the nonlinear echo processor 204. Because the near-end talker is not speaking, a major portion of the signal Sₙ₇ is nonlinear echo derived from the far-end signal, and the non-linear echo processor 204 can cancel the nonlinear echo as much as possible. Otherwise, if the control signal A₁ indicates that the far-end talker is speaking, and the power of the near-end signal Sₙ₇ exceeds a threshold, both the far-end talker and the near-end talker are speaking. Thus, the voice activity detector 205 generates the control signal A₃ to decrease an echo cancellation amount of the nonlinear echo processor 204, and the voices of the near-end talker carried by the signal Sₙ₇ is prevented from being cancelled with nonlinear echo. At the same time, the voice activity detector 205 sends a control signal A₂ to the speaker attenuation module 206, and the speaker attenuation module 206 attenuates the far-end signal S_{f1} to generate the far-end signal S_{f2}. Because the far-end signal S_{f2} is attenuated, the near-end signal carries less amount of echo derived from the far-end signal, and the quality of the near-end signal Sₙ₈ is improved.

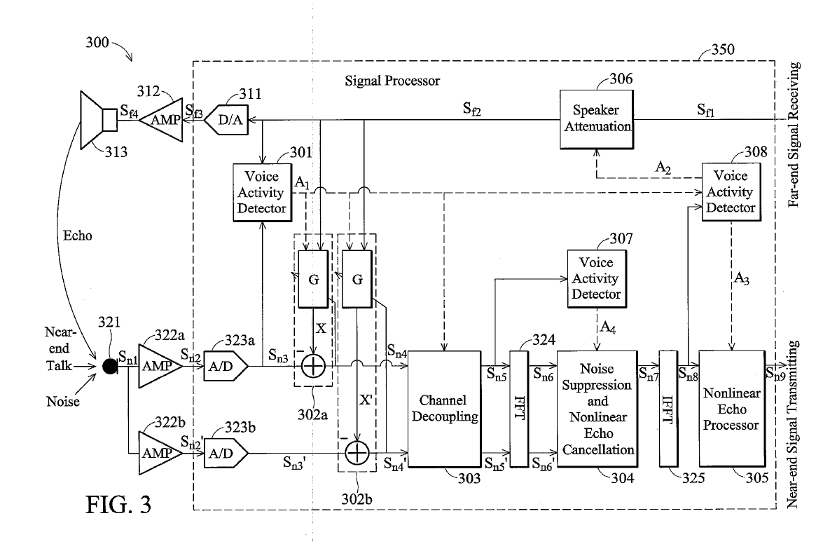

Nonetheless, the signal processor 250 of FIG. 2 still has defects in echo cancellation. Because the voice activity detector 205 detects voices of a near-end talker according to the power of the near-end signal Sₙ₇, the voice activity detector 205 may erroneously consider power of nonlinear echo as power of voices to generate an erroneous control signal A₃. To compensate for the defects, the invention provides more modules for echo cancellation. FIG. 3 is a block diagram of a communication device 300 with a signal processor 350 canceling echo according to the invention. The communication device 300 is roughly similar to the communication device 200 of FIG. 2. The signal processor 250 of the communication device 200 has only one channel for processing the near-end signal. The signal processor 350 of the communication device 300, however, has two channels for processing near-end signals. In addition, a channel decoupling module 303, a noise suppression and nonlinear echo cancellation module 304, and a voice activity detector 307 are added to the signal processor 350 to improve echo cancellation of the signal processor 350.

A microphone 321 converts sounds to a near-end signal Sₙ₁, which is duplicated and amplified by amplifiers 322a and 322b to generate signals Sₙ₂ and Sₙ₂′, respectively, which are input signals of two near-end channels, a main channel and a reference channel. Signals Sₙ₂ to Sₙ₆ are carried by the main channel, and signals Sₙ₂′ to Sₙ₆′ are carried by the reference channel. The signals Sₙ₂ and Sₙ₂′ are first respectively converted from analog to digital to obtain signals Sₙ₃ and Sₙ₃′. Linear echo cancellers 302a and 302b then respectively eliminate linear echo from the signals Sₙ₃ and Sₙ₃′ to obtain signals Sₙ₄ and Sₙ₄′. The channel decoupling module 303 then derives a signal Sₙ₅ comprising less echo and more voices of the near-end talker and a signal Sₙ₅′ comprising more echo and less voices of the near-end talker from the signal Sₙ₄ and the signal Sₙ₄′. Thus, the signal Sₙ₅′ in the reference channel comprises more echo, and the signal Sₙ₅ in the main channel comprises more voices of the near-end talker.

In one embodiment, the channel decoupling module 303 generates the signals Sₙ₅ and Sₙ₅′ according to the control signal A₁. When only the near-end talker is speaking, the channel decoupling module 303 directly outputs the signal Sₙ₄ as the signal Sₙ₅ and subtracts the signal Sₙ₄ from the signal Sₙ₄′ to obtain the signal Sₙ₅′. When only the far-end talker is speaking, the channel decoupling module 303 subtracts the signal Sₙ₄′ from the signal Sₙ₄ to obtain the signal Sₙ₅ and directly outputs the signal Sₙ₄′ as the signal Sₙ₅′. When both the near-end talker and the far-end talker are speaking, the channel decoupling module 303 directly outputs the signal Sₙ₄ as the signal Sₙ₅ and multiplies the signal Sₙ₄′ by a reference gain value less than 1 to generate the signal Sₙ₅′.

A FFT module 324 then performs FFT on the signals Sₙ₅ and Sₙ₅′ to obtain signals Sₙ₆ and Sₙ₆′ in frequency domain. The voice activity detector 307 detects whether the power of the signal Sₙ₅ exceeds a threshold to generate a control signal A₄. The noise suppression and nonlinear echo cancellation module 304 then eliminates noise from the signal Sₙ₆ and cancels nonlinear echo from the signal Sₙ₆ in frequency domain according to the signal Sₙ₆′ of the reference channel and the control signal A₄. Because the signal Sₙ₆ of the main channel comprises more voices and the signal Sₙ₆′ comprises more echo, the noise suppression and nonlinear echo cancellation module 304 takes the signal Sₙ₆′ as a reference signal to remove nonlinear echo from the signal Sₙ₆. An IFFF module 325 then performs IFFT on the signal Sₙ₇ to obtain a signal Sₙ₈. A nonlinear echo processor 305 then removes remnant nonlinear echo from the signal Sₙ₈ to obtain a signal Sₙ₉, which is then transmitted to the far-end talker.

Since the signal processor 350 comprises the noise suppression and nonlinear echo cancellation module 304 canceling nonlinear echo in frequency domain in addition to the nonlinear echo processor 305 canceling nonlinear echo in time domain, the signal Sₙ₉ output by the signal processor 350 comprises less nonlinear echo then the signal Sₙ₈ output by the signal processor 250. Thus, the quality of the near-end signal Sₙ₉ output by the signal processor 350 is better then that of the near-end signal Sₙ₈ output by the signal processor 250.

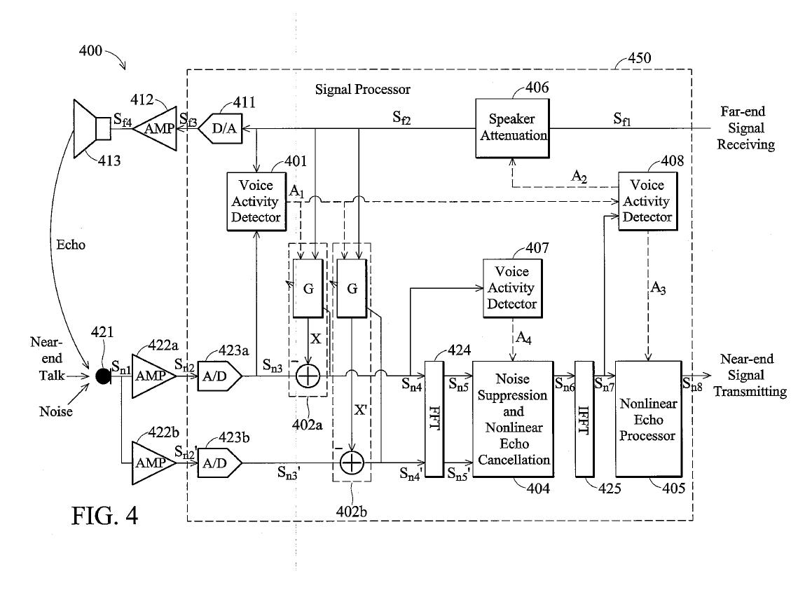

FIG. 4 is a block diagram of a communication device 400 with a signal processor 450 canceling echo according to the invention. The communication device 400 is roughly similar to the communication device 300 of FIG. 3 with the exception that the signal processor 450 lacks a channel decoupling module 303. Without the channel decoupling module 303, the signals Sₙ₄ and Sₙ₄′ in time domain are directly converted by the FFT module 424 to the signals Sₙ₅ and Sₙ₅′ in frequency domain, and the noise suppression and nonlinear echo cancellation module 404 directly takes the signal Sₙ₅′ as a reference signal to remove nonlinear echo from the signal Sₙ₅ in frequency domain to generate a signal Sₙ₆. Thus, a portion of nonlinear echo of the near-end signal Sₙ₅ can still be eliminated in frequency domain.

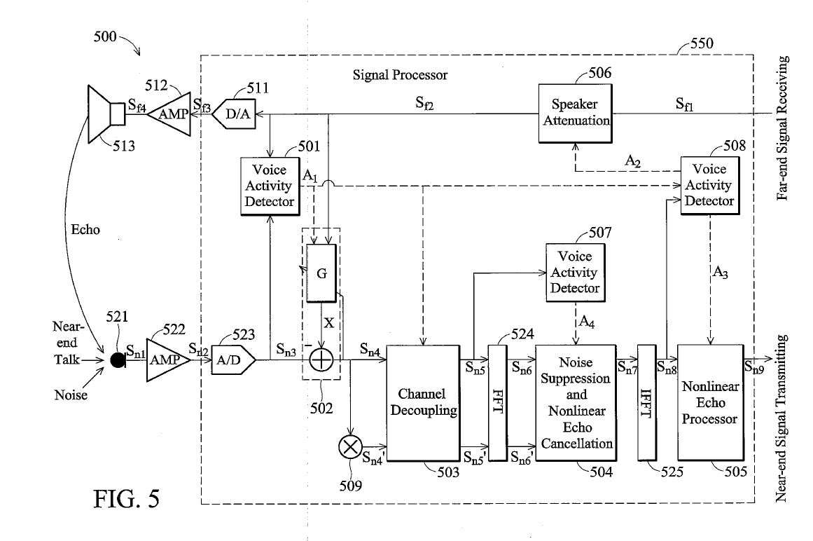

The signal processor 350 of FIG. 3 cancels most nonlinear echo in the near-end signal with the cost of extra circuits of the reference channel, such as the amplifier 322b, the analog-to-digital converter 323b, and the linear echo canceller 302b. If the extra circuits are omitted, the manufacture cost of the signal processor 350 is reduced. FIG. 5 is a block diagram of a communication device 500 with a signal processor 550 canceling echo according to the invention. The communication device 500 is roughly similar to the communication device 300 of FIG. 3 with the exception that extra circuits of the reference channel of the signal processor 550 are removed. Instead, the extra circuits of the reference channel are replaced with a gain controller 509. After a linear echo canceller 502 removes linear echo from a near-end signal Sₙ₃ to obtain a signal Sₙ₄, the gain controller 509 amplifies the signal Sₙ₄ according to a gain value to obtain a signal Sₙ₄′. The signals Sₙ₄ and Sₙ₄′ are then delivered to a channel decoupling module 503 as inputs of a main channel and a reference channel. Thus, the chip costs of the signal processor 550 is reduced.

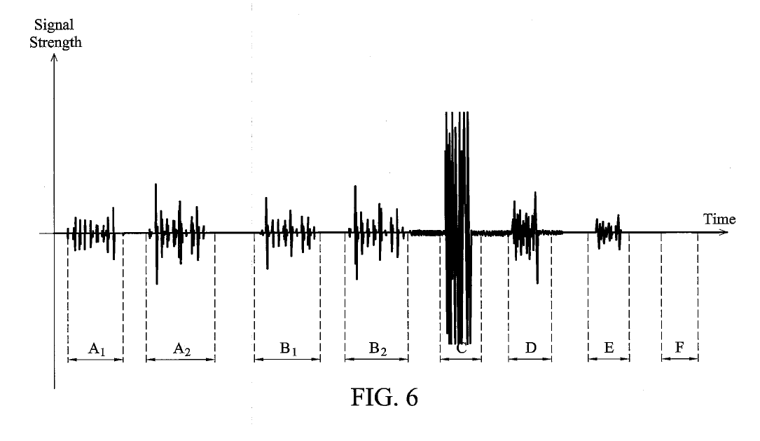

FIG. 6 shows an echo cancellation result of the signal processor 350 of FIG. 3. A region A₁ shows the signal strength (−45 dB) of a segment of near-end signal output by the conventional signal processor 150 when both a near-end talker and a far-end talker are speaking. A region A₂ shows the signal strength (−34.8 dB) of a segment of near-end signal output by the conventional signal processor 150 when only the near-end talker is speaking. Thus, compared to the region A₂, a signal loss of 10.2 dB occurs in the region A₁ when both the near-end talker and the far-end talker are speaking. The signal loss occurs because the nonlinear echo processor 104 cancels voices of the near-end talker with nonlinear echo. Similarly, a region B₁ shows the signal strength (−39.3 dB) of a segment of near-end signal output by the signal processor 350 of FIG. 3 when both a near-end talker and a far-end talker are speaking. A region B₂ shows the signal strength (−35.5 dB) of a segment of near-end signal output by the signal processor 350 when only the near-end talker is speaking. Thus, compared to the region B₂, a signal loss of 3.8 dB occurs in the region B₁ when both the near-end talker and the far-end talker are speaking. Thus, after echo is cancelled from the near-end signal, the near-end signal output by the signal processor 350 suffers a less signal loss than the conventional signal processor 150, and the signal processor 350 provided by the invention generates a near-end signal with higher quality.

Regions C, D, E, and F show the signal strength of a segment of near-end signal output by the signal processor 350 of FIG. 3 when only a far-end talker is speaking. Thus, the signal strengths of regions C, D, E, and F simply reflect strengths of echo derived from a far-end signal. The signal processor 350 comprises multiple echo cancellation modules, such as linear echo cancellers 302a and 302b, frequency-domain nonlinear echo cancellation module 304, and time-domain nonlinear echo processor 305. Regions C, D, E, and F respectively show the signal strengths corresponding to situations in which some of the echo cancellation modules are disabled. The region C shows the signal strength when all echo cancellation modules are disabled. The region D shows the signal strength when only the nonlinear echo cancellers 302a and 302b are enabled, and canceling of 19 dB of linear echo in comparison with region C. The region E shows the signal strength when the linear echo cancellers 302a and 302b and the frequency-domain nonlinear echo cancellation module 304 are enabled, and canceling of another 8 dB of nonlinear echo in comparison with the region D. The region F shows the signal strength when all echo cancellation modules are enabled, and canceling of all echo in comparison with the region E.

The invention provides a signal processor comprising multiple echo cancellation modules for canceling echo of a near-end signal. The echo cancellation modules include a linear echo canceller canceling linear echo, a nonlinear echo cancellation module canceling nonlinear echo in frequency domain, and a nonlinear echo processor canceling echo in time domain. The signal processor also comprises multiple voice activity detectors respectively detecting whether a far-end talker and a near-end talker are speaking to control the echo cancellation modules. The signal processor also comprises a speaker attenuation module attenuating the far-end signal when both the near-end talker and the far-end talker are speaking to reduce generation of echo. Thus, the near-end signal output by the signal processor carries less echo and has a better quality.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A signal processor, installed in a communication device which simultaneously plays a far-end signal sent from a far-end and converts sounds at a near-end to a near-end signal for transmission to the far-end, comprising:
a first voice activity detector, detecting a power of the far-end signal to generate a first control signal indicating whether a far-end talker at the far end is speaking;
a second voice activity detector, generating a second control signal indicating whether both the far-end talker and a near-end talker at the near end are speaking or only the far-end talker is speaking according to power of the near-end signal and the first control signal;
a nonlinear echo processor, controlled by the second control signal, canceling more nonlinear echo from the near-end signal in time domain while only the far-end talker is speaking, and canceling less nonlinear echo from the near-end signal in time domain while both the far-end talker and the near-end talker are speaking; and
a speaker attenuation module, controlled by the second control signal, attenuating the far-end signal while both the far-end talker and the near-end talker are speaking.

2. The signal processor as claimed in claim 1, wherein the signal processor further comprises a linear echo canceller, controlled by the first control signal, canceling linear echo linearly correlated with the far-end signal from the near-end signal.

3. The signal processor as claimed in claim 2, wherein the signal processor further comprises:
a third voice activity detector, detecting a power of the near-end signal to generate a third control signal indicating whether the near-end talker is speaking; and
a nonlinear echo cancellation module, controlled by the third control signal, canceling nonlinear echo from the near-end signal in frequency domain.

4. The signal processor as claimed in claim 3, wherein the signal processor further comprises a channel decoupling module, controlled by the first control signal, deriving a main channel signal and a reference channel signal as inputs of the nonlinear echo cancellation module from the near-end signal, wherein the main channel signal comprises more voices of the near-end talker and less echo, and the reference channel signal comprises less voices of the near-end talker and more echo.

5. The signal processor as claimed in claim 4, wherein the near-end signal is duplicated to generate a duplicated near-end signal, and the near-end signal and the duplicated near-end signal are sent to the channel coupling module as inputs.

6. The signal processor as claimed in claim 5, wherein the channel decoupling module directly outputs the near-end signal as the main channel signal and subtracts the near-end signal from the duplicated near-end signal to obtain the reference channel signal when only the near-end talker is speaking, the channel decoupling module subtracts the duplicated near-end signal from the near-end signal to obtain the main channel signal and directly outputs the duplicated near-end signal as the reference channel signal when only the far-end talker is speaking, and the channel decoupling module directly outputs the near-end signal as the main-channel signal and multiplies the duplicated near-end signal by a reference gain value less than 1 to generate the reference channel signal when both the near-end talker and the far-end talker are speaking.

7. The signal processor as claimed in claim 5, wherein the duplicated near-end signal is generated outside the signal processor.

8. The signal processor as claimed in claim 5, wherein the signal processor further comprises a gain controller, multiplying the near-end signal with a gain value to obtain the duplicated near-end signal.

9. A method for canceling echo in a communication device, wherein the communication device simultaneously plays a far-end signal sent from a far-end and converts sounds at a near-end to a near-end signal for transmission to the far-end, the method comprising:
determining whether both a far-end talker at the far end and a near-end talker at the near end are speaking or only the far-end talker is speaking;
canceling more nonlinear echo from the near-end signal in time domain while only the far-end talker is speaking;
canceling less nonlinear echo from the near-end signal in time domain while both the far-end talker and the near-end talker are speaking; and
attenuating the far-end signal while both the far-end talker and the near-end talker are speaking.

10. The method as claimed in claim 9, wherein the determining step comprises:
detecting a power of the far-end signal to detect whether the far-end talker is speaking; and
detecting a power of the near-end signal to detect whether the near-end talker is speaking.

11. The method as claimed in claim 9, wherein the method further comprises canceling linear echo linearly correlated with the far-end signal from the near-end signal.

12. The method as claimed in claim 11, wherein the method further comprises canceling nonlinear echo from the near-end signal in frequency domain.

13. The method as claimed in claim 12, wherein the cancellation of nonlinear echo in frequency domain is according to a main-channel signal and a reference channel signal, and the method further comprises:
duplicating the near-end signal to generate a duplicated near-end signal; and
deriving the main channel signal comprising more voices of the near-end talker and less echo, and the reference channel signal comprising less voices of the near-end talker and more echo from the near-end signal and the duplicated near-end signal.

14. The method as claimed in claim 13, wherein the separating step further comprises:
when only the near-end talker is speaking, directly outputting the near-end signal as the main channel signal and subtracting the near-end signal from the duplicated near-end signal to obtain the reference channel signal;
when only the far-end talker is speaking, subtracting the duplicated near-end signal from the near-end signal to obtain the main channel signal and directly outputting the duplicated near-end signal as the reference channel signal; and
when both the near-end talker and the far-end talker are speaking, directly outputting the near-end signal as the main-channel signal and multiplying the duplicated near-end signal by a reference gain value less than 1 to generate the reference channel signal.

15. The method as claimed in claim 13, wherein the duplicated near-end signal is obtained by multiplying the near-end signal with a gain value.
